(19) United States
(12) Patent Application Publication
(10) Pub. No.: US 2025/0076214 A1
(43) Pub. Date: Mar. 6, 2025

(54) ROPE EVALUATION SYSTEMS AND METHODS

(71) Applicant: Scope Computer Vision Technologies Corp, Sugar Land, TX (US)

(72) Inventors: Samuel Justin McCoy, Sugar Land, TX (US); Jacob MIchael Kurtz Poroo, JR., Sugar Land, TX (US); John D. Spencer, III, Grand Rapids, MI (US); Matthew T. Shaver, Grand Rapids, MI (US)

(21) Appl. No.: 18/882,503

(22) Filed: Sep. 11, 2024

Related U.S. Application Data
(63) Continuation-in-part of application No. 18/093,214, filed on Jan. 4, 2023.
Application No. 18/093,214 is a continuation-in-part of application No. PCT/US2021/050761, filed on Sep. 16, 2021.
(60) Provisional application No. 63/608,081, filed on Dec. 8, 2023.
(60) Provisional application No. 63/079,185, filed on Sep. 16, 2020.

(51) Int. Cl. G01N 21/95

(52) U.S. Cl. CPC G01N 21/95

(57) ABSTRACT

A system for evaluating rope, the system may include a scope body having an inlet end defining an inlet and an outlet end defining an outlet, the scope body defining a geometry to receive a rope, and at least one light disposed in the scope body to illuminate the rope as it traverses the scope body. The system may further include at least one sensor disposed in the scope body, the at least one sensor to sense at least one rope parameter from the rope as the rope traverses through the scope body and an evaluation module electrically connected to the at least one sensor to receive the at least one rope parameter and determine a rope condition based on the at least one rope parameter.

### CROSS-REFERENCE TO RELATED APPLICATIONS

This application is related to and claims priority under 35 U.S.C. § 119(e) from U.S. Provisional Application No. 63/608,081 filed Dec. 8, 2023, titled “Rope Evaluation Systems and Methods,” the entire contents of which is incorporated herein by reference for all purposes.

This application is also a Continuation-in-Part of U.S. Nonprovisional application Ser. No. 18/093,214 filed Jan. 4, 2023, titled “Systems and Methods for Rope Evaluation, which is a Continuation-in-Part of International Application No. PCT/US2021/050761 filed Sep. 16, 2021, titled “Rope Evaluation Systems and Methods”, which claims benefit of priority under 35 U.S.C. § 119(e) from U.S. Provisional Application No. 63/079,185 filed Sep. 16, 2020, titled “Rope Evaluation Systems and Methods,”, all of which are hereby incorporated by reference in their entirety.

### BACKGROUND

Ropes are used in the multiple industries, including the maritime industry and utility industries, in various capacities to, for example, hold and secure vessels while they are docked and/or move and secure cargo. Through normal use, the ropes may be exposed to loading scenarios of thousands and hundreds of thousands of pounds. Over time, such scenarios may cause the ropes to become damaged. A damaged rope may become a liability because a damaged rope may not be capable of securing a load as intended.

Identification of damage to ropes traditionally involves the manual visual inspection of the ropes. Individuals look at sections of a rope in an attempt to identify areas of the rope that may be damaged. This manual inspection of rope is labor intensive and often results in levels of unpredictability, as each individual's interpretation of what constitutes damage is not consistent. As such, damaged rope may not be correctly identified, thereby resulting in damaged rope being used in operations. Use of damaged rope may result in rope failure that may cause dangerous conditions during normal operations.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a side perspective view of a scope device, according to one or more examples of the disclosure.

FIG. 2 is an end plan view of a scope device, according to one or more examples of the disclosure.

FIG. 3 is a side plan view of a scope device, according to one or more examples of the disclosure.

FIG. 4 is an end plan view of a scope device, according to one or more examples of the disclosure.

FIG. 5 is a side perspective view of a scope device, according to one or more examples of the disclosure.

FIG. 6 is a side plan view of a scope device, according to one or more examples of the disclosure.

FIG. 7 is an end perspective view of a scope device having a rope traversing therethrough, according to one or more examples of the disclosure.

FIG. 8 is side plan view of a scope device, according to one or more examples of the disclosure.

FIG. 9 is a perspective end view of a scope device, according to one or more examples of the disclosure.

FIG. 10 is a side plan view of a scope device, according to one or more examples of the disclosure.

FIG. 11 is a side plan view of a scope device, according to one or more examples of the disclosure.

FIG. 12 is a side perspective view of a scope device, according to one or more examples of the disclosure.

FIG. 13 is an end plan view of a scope device, according to one or more examples of the disclosure.

FIG. 14 is a side perspective view of a scope device, according to one or more examples of the disclosure.

FIG. 15 is a side plan view of a scope device, according to one or more examples of the disclosure.

FIG. 16 is an end plan view of a scope device, according to one or more examples of the disclosure.

FIG. 17 is an end perspective view of a scope device, according to one or more examples of the disclosure.

FIG. 18 is an end plan view of a scope device, according to one or more examples of the disclosure.

FIG. 19 is a side perspective view of a scope device, according to one or more examples of the disclosure.

FIG. 20 is an end plan view of a scope device, according to one or more examples of the disclosure.

FIG. 21 is an end perspective view of a scope device, according to one or more examples of the disclosure.

FIG. 22 is a top perspective view of a scope device, according to one or more examples of the disclosure.

FIG. 23 is an example evaluation module output, according to one or more examples of the disclosure.

FIG. 24 is an example evaluation module output, according to one or more examples of the disclosure.

FIG. 25 is a rope for evaluation, according to one or more examples of the disclosure.

FIG. 26 is a rope with identified rope picks, according to one or more examples of the disclosure.

FIG. 27 is a rope with pick anomalies identified, according to one or more examples of the disclosure.

FIG. 28 is a flowchart of a method for evaluating rope, an example evaluation module output, according to one or more examples of the disclosure.

FIG. 29 is a flowchart of a method for evaluating rope, an example evaluation module output, according to one or more examples of the disclosure.

FIG. 30 is a computer system that may be used to evaluate a rope, according to one or more examples of the disclosure.

FIG. 31 is a front side view of a scope device, according to one or more examples of the disclosure.

FIG. 32 is a back side view of a scope device, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As briefly discussed above, rope used in industrial applications, such as the maritime industry, may become damaged over time as a result of normal wear and tear experienced through the successive application of loads thereto. As damaged rope may result in hazardous working conditions should a rope fail, identification of failure points on a rope is critical in providing safe working conditions. The typical methodology of identifying failure points on a rope is not consistent, thereby resulting in incorrect or missed failure point identification.

The present disclosure may provide systems and methods for identification of rope failure points prior to failure, thereby allowing the rope to be repaired or replaced before failure. As the systems and methods may be substantially automated, a real time or substantially real time analysis of rope conditions may be provided, thereby increasing the efficiency of rope analysis. Real time and substantially real time refer to an automatic analysis that occurs as close in time as possible to when the original sensing occurs. By increasing the efficiency of rope analysis, rope may be analyzed more quickly and less expensively, thereby allowing for more rope to be analyzed, further increasing the safety of working conditions. The methods and systems disclosed herein may or may not be used in conjunction with visual inspection such as is currently performed in the industry.

The systems and methods provided herein may also provide for modular rope analysis that may be temporarily used on maritime vessels on an as needed basis. In certain embodiments, the rope analysis systems may be used on a substantially continuous basis, thereby allowing an up to date rope condition to be determined. In still other embodiments, a database of rope conditions may be created, thereby allowing for rope evaluation modules to be trained and updated, increasing the accuracy of the rope analysis. For example, in certain embodiments, artificial neural networks may be used to receive information about a specific rope and determine, based on machine learning, a condition of the rope. The condition of the rope may subsequently be used to further train the artificial neural network, thereby allowing for quicker and more accurate rope analysis.

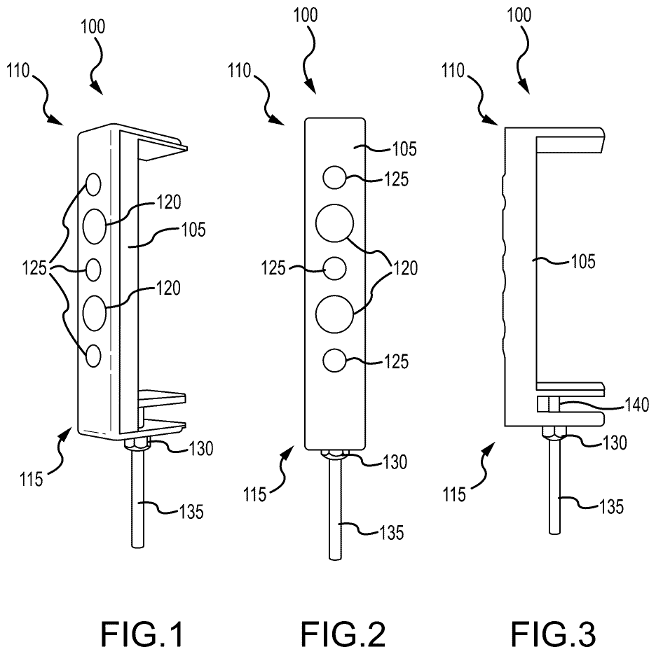

Referring to FIGS. 1, 2, and 3 together, a side perspective view, an end view, and a side view of a scope, according to one or more embodiments of the present disclosure are shown. In this embodiment, a scope 100 is shown having a scope body 105. The scope body 105 includes an inlet end 110 and an outlet end 115. Inlet end 110 may be configured to receive a rope (not shown) as the rope traverses scope body 105. After analysis, which is described in detail below, the rope may pass out of scope body 105 through outlet end 115. In other embodiments, a rope may pass over or by inlet end 110, traverse all or a portion of scope body 105 and exit outlet end 115. Alternative embodiments are discussed in detail below.

Scope 100 may further include one or more sensors 120 disposed on scope body 105. In this embodiment, scope 100 includes two sensors 120, however, in other embodiments, scope 100 may include one sensor or more than two sensors, such as, for example, three, four, five, six or more sensors. The type of sensors 120 that are used may vary depending on the requirements of the operation. Examples of types of sensors 120 may include cameras, infrared sensors, x-ray sensors, pixel-based sensors, laser, sonar, ultrasound, computed tomography sensors, and the like. As such, sensors 120 may be used to collect data on a rope as the rope traverses scope 100.

Scope 100 may further include one more light sources 125. In this embodiment, scope 100 includes three light sources 125, however, in other embodiment, scope 100 may include fewer or greater light sources 125. In still other embodiments, certain scopes 100 may not require light sources 125. Examples of light sources may include, for example, light emitting diodes (“LED”). In this embodiment, light sources 125 are disposed between sensors 120, thereby providing illumination of a rope as the rope passed by sensors 120.

Scope 100 may further include an attachment mechanism 130, Attachment mechanism 130 may include a rotatable end 135 that may be used to secure scope 100 to a desired surface. In this embodiment, attachment mechanism 130 is shown as being rotatable by using a screw interface 140. However, in other embodiments, attachment mechanism 130 may be slidable, wedgeable, on a pivot, magnetically, or otherwise mechanically attachable. In still other embodiments, attachment mechanism 130 may be chemically attachable, such as through an adhesive, that allows for a temporary or permanent attachment of scope 100 to a desired surface.

During operation, scope 100 may be connected to an evaluation module (not shown in FIGS. 1-3), which is described in greater detail below. Scope 100 may be connected to the evaluation module through either a wired or wireless connection. Examples of wireless connections may include Bluetooth, Wi-Fi, radio frequency, and the like. The evaluation module may receive one or more rope parameters that are recorded or otherwise measured by one or more of sensors 120. The evaluation module may thereby use the rope parameters to determine a rope condition. The rope condition may include a determination of whether the rope has entered a failure mode that would require further action.

Depending upon the implementation, the evaluation module may be hardware, software, or some combination of software. For example, in some examples, the evaluation module may be some kind of processing resource executing instructions stored in a memory of some kind. In other examples, the evaluation module may be implemented in an appropriately programmed device such as an electrically erasable, programmable, read only memory (“EEPROM”). In still other examples, the evaluation module may be an application specific integrated circuit (“ASIC”). Those in the art having the benefit of this disclosure may realize still other implementations for the evaluation module. One particular implementation is discussed further below.

For example, if the evaluation module determines that a specific rope has entered a failure mode, the evaluation module may issue an alert. The alert may include, for example, a visual or auditory notification to an operator that a rope or a section of a rope is no longer in proper operating condition. The evaluation module may simply issue the alert or, in certain embodiments, may advise a particular action. For example, an evaluation module may issue the alert to an operator and indicate that the rope would be either repaired or replaced. The evaluation module may further provide an operator with a location of the failure so that the operator may manually inspect the section of the rope identified as being in a failure mode. Aspects of the evaluation module and the evaluation module logic are discussed in detail below.

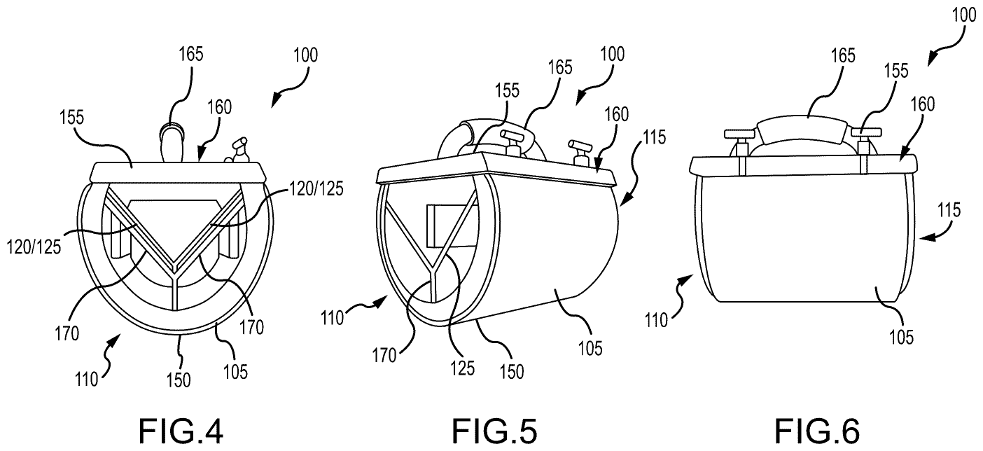

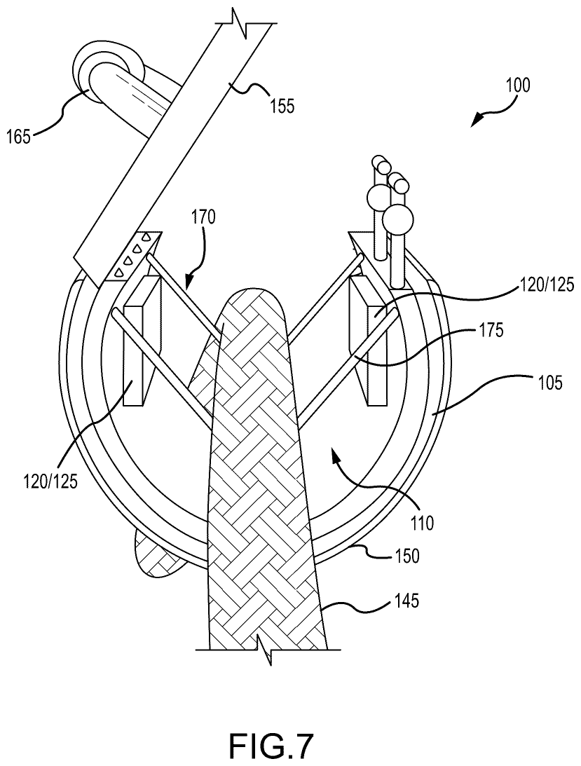

Referring to FIGS. 4, 5, 6, and 7, an end plan view, a side perspective view, a side plan view, and another end perspective view of a scope, according to one or more embodiments of the present disclosure are shown. In this embodiment, the scope 100 is shown having a scope body 105. The scope body 105 includes an inlet end 110 and an outlet end 115. Inlet end 110 may be configured to receive a rope 145 (FIG. 7) as the rope traverses scope body 105. After analysis, the rope 145 may pass out of scope body 105 through outlet end 115.

Scope 100 may further include one or more sensors 120, disposed on scope body 105. In this embodiment, scope 100 includes two sensors 120. Sensors 120 may be used to collect data on rope 145, as the rope traverses scope 100. Scope 100 may further include one more light sources 125.

In this embodiment, scope 100 includes a curvilinear geometry along a bottom portion 150 and a retractable portion 155 along a top portion 160. The retractable portion 155 may include a handle 165, thereby allowing an operator to open the scope 100 to inspect rope 145. Handle 165 may also be used by an operator to move scope 100 to various locations on a vessel (not shown), thereby allowing scope 100 to be modularly disposed at desired locations to provide analysis of one or more ropes 145 at different locations.

Scope 100 may further include a support structure 170 (shown in detail in FIG. 7). Support structure 170 may include one or more support sections 175 that allow rope 145 to pass through scope 100 at a selected location. As illustrated, support sections 175 direct rope 145 through scope 100 in front of sensors 120. Support sections 175 may include metal, metal alloy, plastic, composite, and other types of materials that guide rope 145 in a desired direction within scope body 105. As illustrated, support sections 175 form a V-shaped guide that directs rope 145, however, in other embodiments, support sections 175 may include rectangular, circular, semi-circular, or other geometrical formation that allow rope 145 to pass in front of sensors 120 and or light sources 125 at a desired orientation. As such, sensors 120 have a substantially constant and consistent vantage point for gathering rope parameters as rope 145 traverses scope 100. In certain embodiments, support structure 170 may be movable, thereby allowing scope 100 to be adaptable to different types of rope 145. For example, support structure 170 may be movable upwardly, downwardly, or side-to-side to allow different rope 145 having varying diameters to be measured and analyzed.

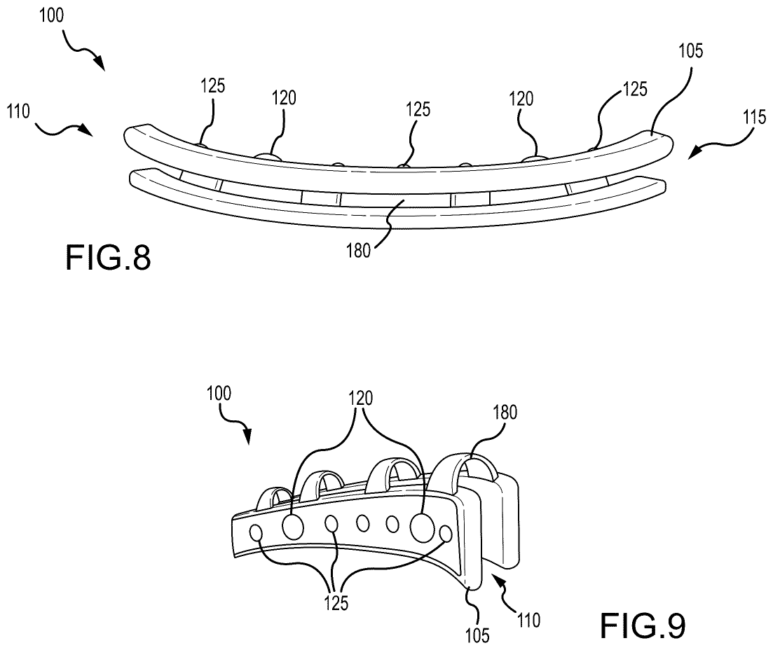

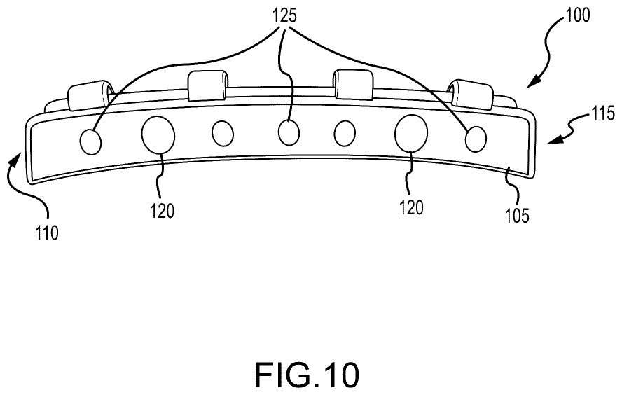

Referring to FIGS. 8, 9, and 10, a side view, a perspective end view, and a side view of a scope, according to one or more embodiments of the present disclosure are shown. In this embodiment, a scope 100 is shown having a scope body 105. The scope body 105 includes an inlet end 110 and an outlet end 115. Inlet end 110 may be configured to receive a rope as the rope traverses scope body 105. After analysis, the rope may pass out of scope body 105 through outlet end 115.

Scope 100 may further include one or more sensors 120, disposed on scope body 105. In this embodiment, scope 100 includes two sensors 120. Sensors 120 may be used to collect data on the rope as the rope traverses scope 100. Scope 100 may further include one more light sources 125. In this embodiment, scope 100 includes five light sources 125.

Scope 100 may further include a magnetized pad clamp 180, thereby allowing scope 100 to be temporarily attachable to various locations for rope analysis. Magnetized pad clamp 180 may include rubber surfaces over the top of the magnetized portions that allow scope 100 to be attached to various ferrous substrates without damaging the attachment surfaces. Scope 100 further includes a substantially arcuate geometry that may be bendable for securement to curved surfaces. While in certain embodiments scope 100 may be bendable/flexible, in other embodiments, the external and internal geometry of scope 100 may be substantially fixed and thus designed to fit on a surface having a particular matching geometry. Scope 100 may further be configured to be movable, thereby allowing scope 100 to be temporarily mounted to particular locations and after analysis, be moved to other locations.

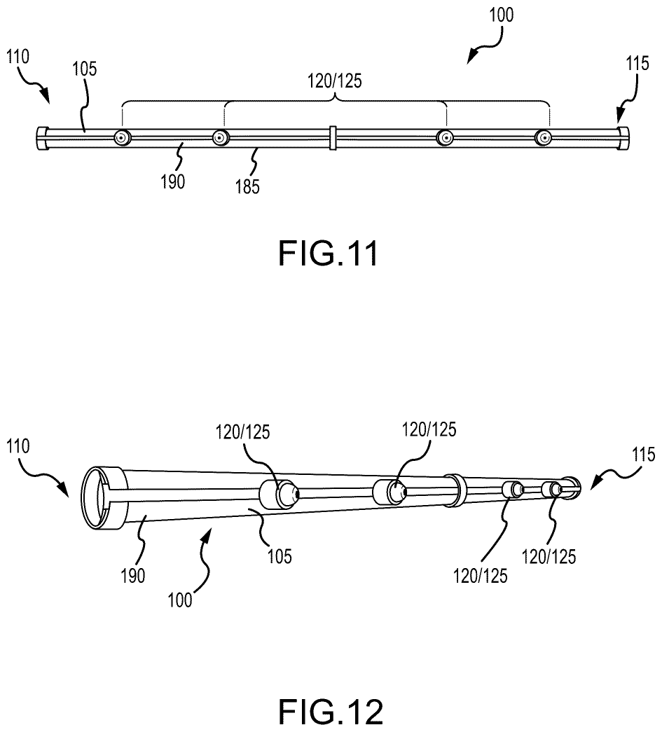

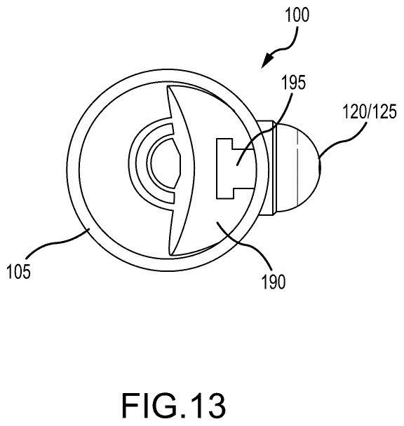

Referring to FIGS. 11, 12, and 13, a side plan view, a side perspective view, and an end plan view of a scope, according to one or more embodiments of the present disclosure are shown. In this embodiment, a scope 100 is shown having a scope body 105. The scope body 105 includes an inlet end 110 and an outlet end 115. Inlet end 110 may be configured to receive a rope as the rope traverses scope body 105. After analysis, the rope may pass out of scope body 105 through outlet end 115.

Scope 100 may further include one or more sensors 120, disposed on scope body 105. In this embodiment, scope 100 includes two sensors 120. Sensors 120 may be used to collect data on the rope as the rope traverses scope 100. In this embodiment, scope 100 includes light sources 125 that are integrated within sensors 120.

Scope 100 includes a sliding rail 185 that is incorporated into scope body 105, thereby allowing scope 100 to be attached to various locations, such as along pipes or railing. Sensors 120 may be disposed within notches 190. Notches 190 may include grooved surfaces (not shown) that allow sensors 120 to slide horizontally therethrough. As such, sensors 120 may be moved horizontally into a position to more accurately gather information as a rope passes. Scope 100 may further include one or more sensor stops 195 that define a horizontal location where sensors 120 may be located. As light sources 125 are integrated into sensors 120 and, as sensors 120 move horizontally within notches 190, the light sources 125 may also be configured to provide illumination at an optimal location.

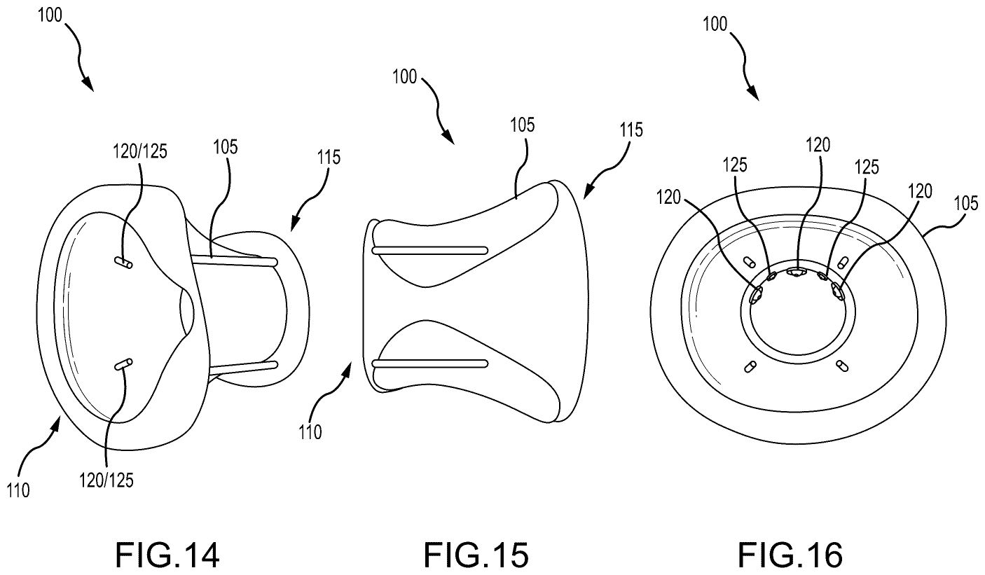

Referring to FIGS. 14, 15, and 16, a side perspective view, a side plan view, and an end plan view of a scope, according to one or more embodiments of the present disclosure are shown. In this embodiment, a scope 100 is shown having a scope body 105. The scope body 105 includes an inlet end 110 and an outlet end 115. Inlet end 110 may be configured to receive a rope as the rope traverses scope body 105. After analysis, the rope may pass out of scope body 105 through outlet end 115.

Scope 100 may further include one or more sensors 120, disposed on scope body 105. In this embodiment, scope 100 includes two sensors 120. Sensors 120 may be used to collect data on the rope as the rope traverses scope 100. Scope 100 may further include one more light sources 125. In this embodiment, scope 100 includes two light sources 125.

In this embodiment, scope 100 is configured to be disposed in a chock, i.e., the exiting point for rope on a vessel, such that as rope is fed through the chock, the rope may be substantially continuously analyzed. Scope 100 includes a substantially circular geometry that extends around a rope as the rope traverses scope 100. As illustrated, the inlet end 110 includes a volume that is greater than the outlet end 115. Accordingly, as a rope traverses through scope 100, the rope may be funneled to a particular location within scope 100, thereby allowing the rope to be analyzed at a desired location. In other embodiments, the volume of inlet end 110 and outlet end 115 may be substantially the same, while in still other embodiments, the volume of inlet end 110 may be less than the volume of outlet end 115. Said another way, the volume of the inlet, where a rope is received may have a wider or larger opening then the volume of the outlet, where the rope exits scope 100. In other embodiments, the inlet and outlet may be substantially similar, having a geometry of substantially the same volume. The geometry of scope 100 may thereby be adjusted based on the conditions of a particular operation.

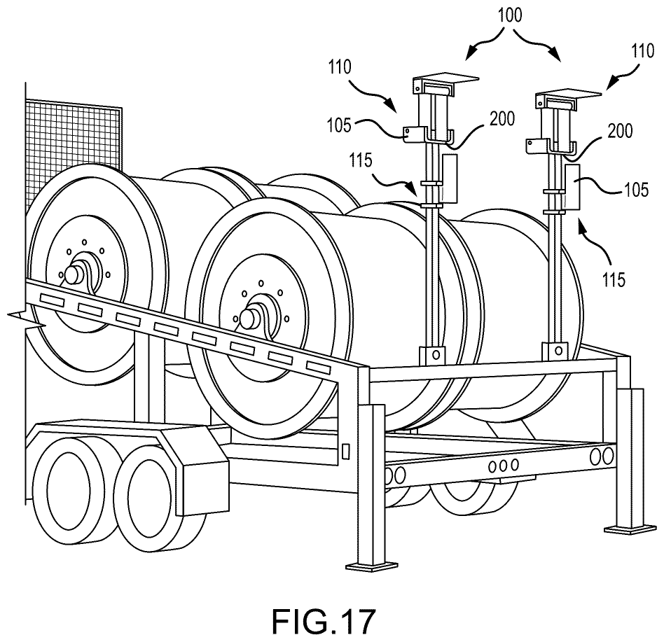

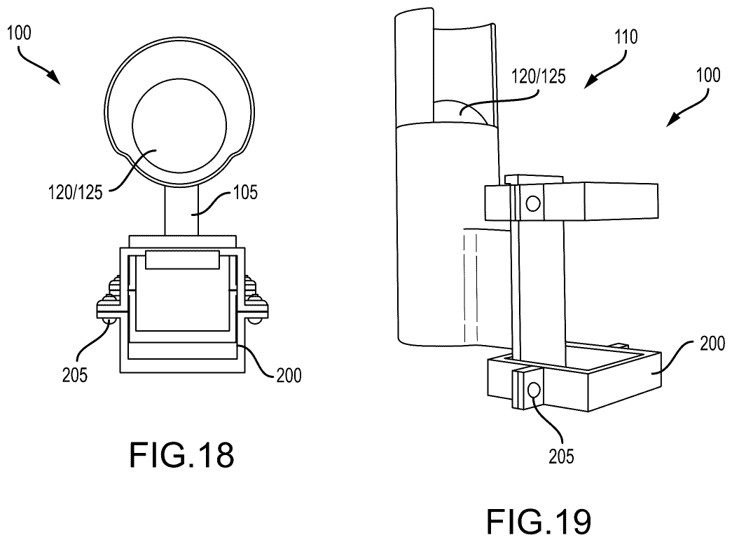

Referring to FIGS. 17, 18, and 19, an end perspective view, an end plan view, and a side perspective view of a scope, according to one or more embodiments of the present disclosure are shown. In this embodiment, a scope 100 is shown having a scope body 105. The scope body 105 includes an inlet end 110 and an outlet end 115. Inlet end 110 may be configured to receive a rope as the rope traverses scope body 105. After analysis, the rope may pass out of scope body 105 through outlet end 115.

Scope 100 may further include one or more sensors 120, disposed on scope body 105. In this embodiment, scope 100 includes two sensors 120. Sensors 120 may be used to collect data on the rope as the rope traverses scope 100. Scope 100 may further include one more light sources 125. In this embodiment, scope 100 includes light sources 125 that are integrated within sensors 120.

In this embodiment, scope 100 is mountable to various structures, such as square or round structures, thereby allowing scope 100 to be temporarily mounted to specific and desired locations. Scope 100 includes a mounting hardware 200 that may be used to secure scope 100 to a specific location. In this embodiments, mounting hardware 200 includes screw 205 that may be tightened and loosened to facilitate the mounting of scope 100 to specific locations. As shown, in operation, multiple scopes 100 may be attached to spooling locations (FIG. 17), thereby allowing multiple strands of rope to be analyzed at the same time or at substantially the same time.

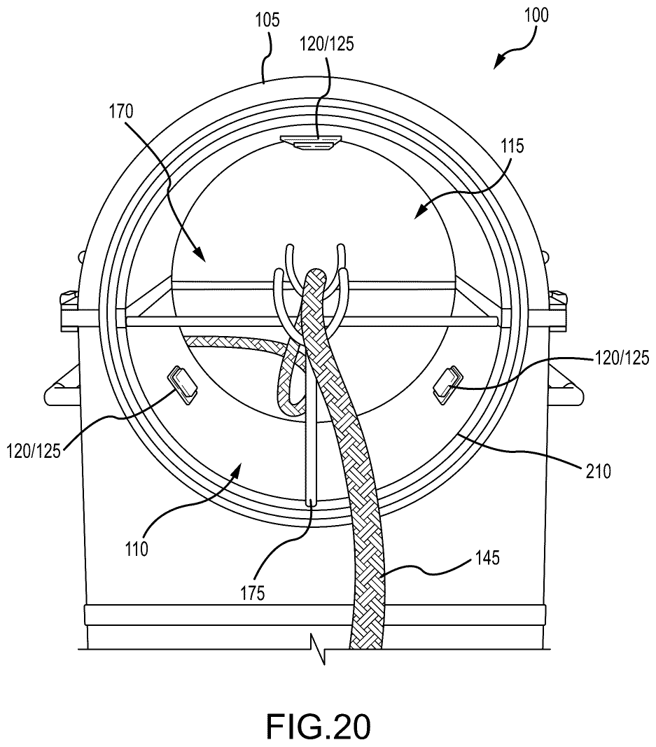

Referring to FIG. 20, an end plan view of a scope, according to one or more embodiments of the present disclosure is shown. In this embodiment, a scope 100 is shown having a scope body 105. The scope body 105 includes an inlet end 110 and an outlet end 115. Inlet end 110 may be configured to receive a rope 145 as the rope 145 traverses scope body 105. After analysis, the rope 145 may pass out of scope body 105 through outlet end 115.

Scope 100 may further include one or more sensors 120, disposed on scope body 105. In this embodiment, scope 100 includes two sensors 120. Sensors 120 may be used to collect data on the rope as the rope traverses scope 100. Scope 100 may further include one more light sources 125.

Scope 100 may further include a support structure 170. Support structure 170 may include one or more support sections 175 that allow rope 145 to pass through scope 100 at a selected locations. As illustrated, support sections 175 direct rope 145 through scope 100 in front of sensors 120. As such, sensors 120 have a substantially constant and consistent vantage or gathering rope parameters as rope 145 traverses scope 100. In certain embodiments, support structure 170 may be movable, thereby allowing scope 100 to be adaptable to different types of rope 145. For example, support structure 170 may be movable upwardly, downwardly, or side-to-side to allow different rope 145 having varying diameters to be measured and analyzed.

In this embodiment, scope 100 is a substantially contained unit that may be placed at a specific location to allow rope 145 to be analyzed. The passage through scope body 105 extends 360 degrees in a circular geometry, thereby providing a round orifice 210 through which rope 145 may traverse. As scope body 105 extends 360 degrees, sensors 120 and lights 125 may be placed at selected locations to gather data about rope 145 effectively.

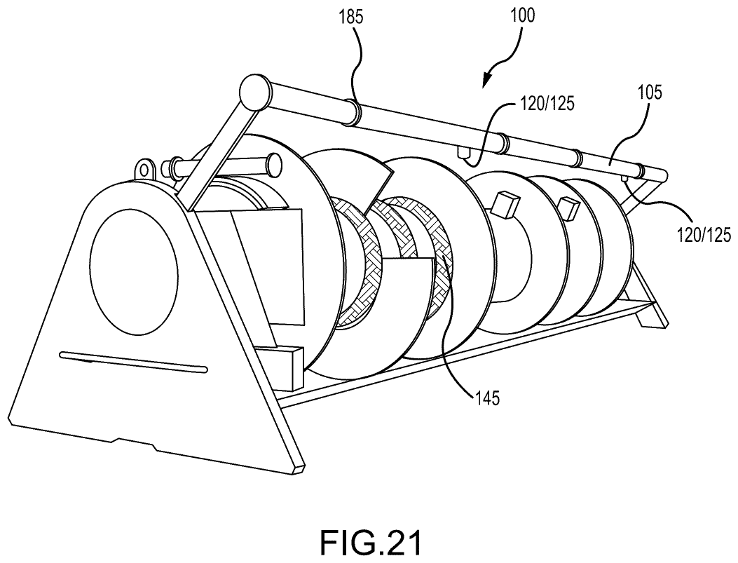

Referring to FIG. 21, an end perspective view of a scope, according to one or more embodiments of the present disclosure is shown. In this embodiment, a scope 100 is shown having a scope body 105. The scope body 105 may be configured to receive a rope 145 as the rope 145 traverses below scope body 105.

Scope 100 may further include one or more sensors 120, disposed on scope body 105. In this embodiment, scope 100 includes two sensors 120. Sensors 120 may be used to collect data on the rope 145 as the rope 145 traverses below scope body 105. In this embodiment, scope 100 includes light sources 125 that are integrated within sensors 120.

Scope 100 includes a sliding rail 185, as described above with respect to FIGS. 1113, thereby allowing scope 100 to be attached to various locations. In this embodiment, scope 100 is illustrated disposed above multiple spools of rope 145, thereby allowing multiple ropes 145 to be analyzed. As sensors 120 are slidable along sliding rail 185, scope 100 may be retrofitted to position sensors 120 at specific locations. As such, as the location of rope 145 changes, sensors 120 may be moved to optimal sensing locations.

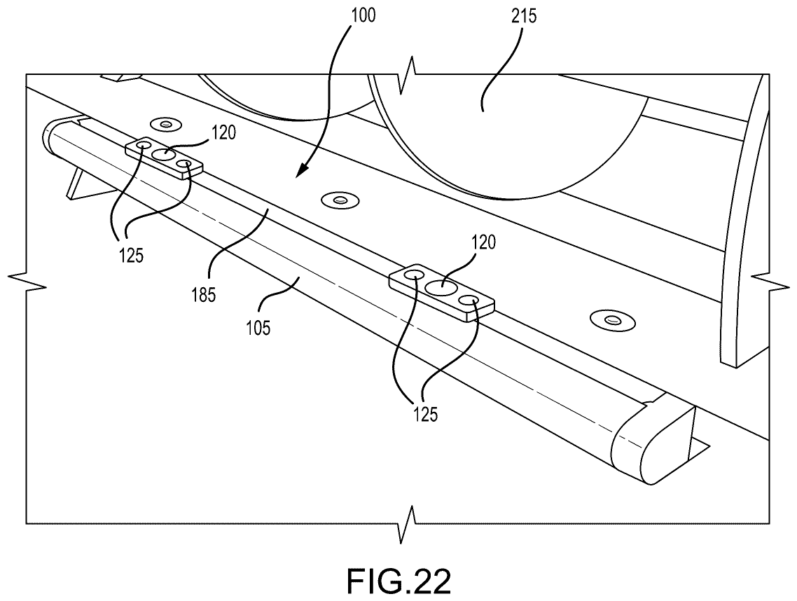

Referring now to FIG. 22, a top perspective view of a scope, according to one or more embodiments of the present disclosure is shown. In this embodiment, a scope 100 is shown having a scope body 105. The scope body may be configured to receive a rope as the rope traverses scope body 105.

Scope 100 may further include one or more sensors 120, disposed on scope body 105. In this embodiment, scope 100 includes two sensors 120. Sensors 120 may be used to collect data on the rope as the rope traverses scope 100. In this embodiment, scope 100 includes light sources 125 that are integrated within sensors 120.

Scope 100 includes a sliding rail 185, as described above with respect to FIGS. 1113 and 21. Scope 100 is illustrated disposed below a rope spool 215. Scope 100 further includes sensors 120 that are slidable long sliding rail 185 but are not bound by a limitation as to how far sensors 120 may be spaced apart. As such, sensors 120 may be disposed at any location on scope body 105.

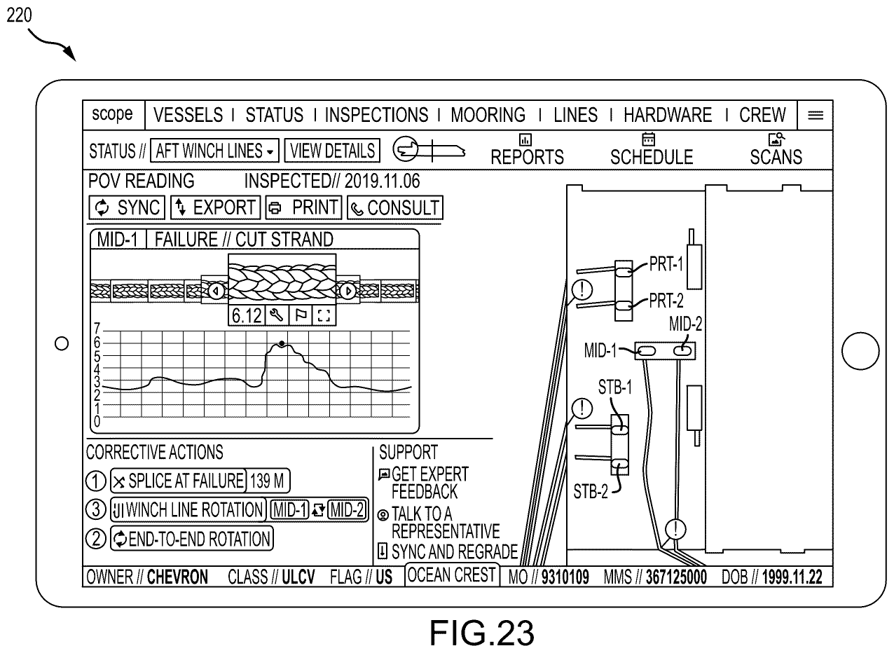

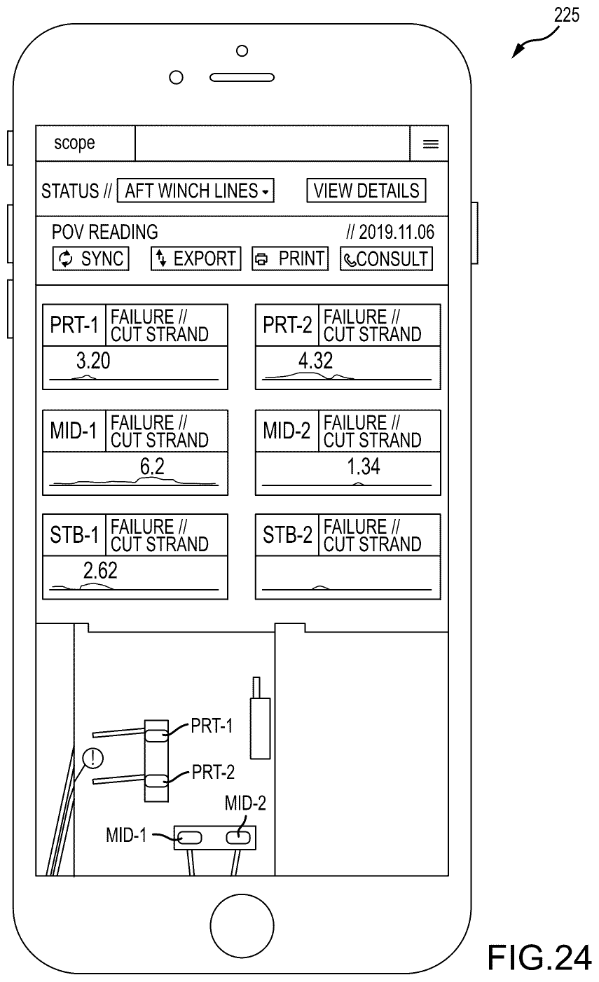

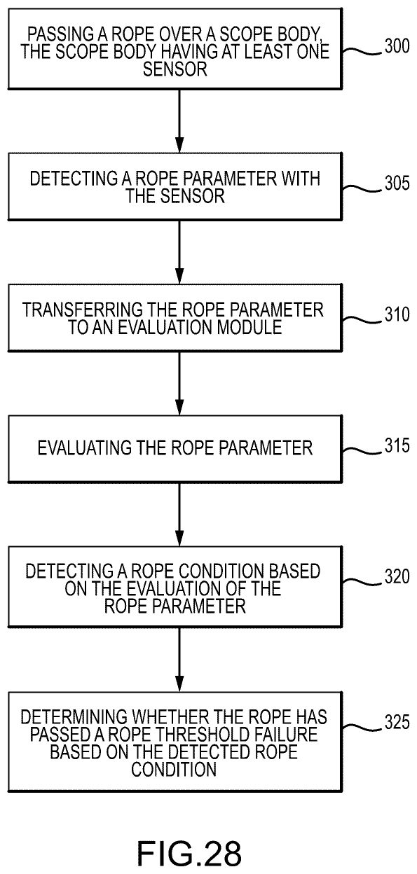

Referring to FIGS. 23 and 24, example evaluation module outputs, according to one or more embodiments of the present disclosure are shown. In operation, the sensors, such as those in the systems discussed above, may provide information to an evaluation module. Information may include rope parameters, such as, for example, a rope length, a rope material, a pick number, a pick distance, a relative pick distance, a distance between picks, a pick threshold, a failure mode, a wear factor, a break, an erosion, a fray value, a thermal property, a remediation, and/or otherwise other measured or defined aspects of a rope. Aspects of the evaluation module are discussed below with respect to FIG. 28.

The evaluation module output that may be sent to operator devices. Examples of operator devices may include a tablet 220, which is illustrated in FIG. 23, a phone 225, which is illustrated in FIG. 24, a computer, a proprietary device, or other devices capable of displaying information outputted from the evaluation module. The output may include various information about a rope or multiple ropes used in particular operations For example, evaluation module output may include information on vessels, vessel specifications, rope/line inspection information, hardware inspection information, forward line/rope inspection information, total mooring hours, line/rope position, external rope ratings, internal rope ratings, line/rope health, failure modes, failure mode location, failure mode frequency, failure mode severity, remediation recommendations, visual rope schematics, recommended remediating action, alter to consult an expert, recommended best practice, incoming messages and alerts, upcoming maintenance schedules, and/or other information related to specific operations.

Through the user interface of operator devices, various information may be aggregated to display to an operator, thereby allowing the operator to use the information and control algorithms of the evaluation module. Through the user interface, an operator may, for example, initiate an inspection of a rope, switch ropes to be inspected, display inspection results, initiate optimal line rotation, view predicted results, view predicted results within a time frame, view predicted results within a time frame based on rotation, identify a rope health status, initiate replacement or remediation of a specific rope, initiate a review of rope inspection data by an operator, or perform other actions that may be specific to an operation or operational requirement.

The operator devices may connect to the evaluation module through wired or wireless connections, such as through an Internet connection. After a connection is established, the operator device may offload inspection results to a cloud platform that is specific for a client. On the cloud platform, the evaluation module may use the inspection results, including any inspection data, to advance the learning of other devices that are also using the interface. The inspection data may be accessible for duplicate user interfaces for particular vessels and may be categorized as requested by specific clients. In the cloud platform, historical data for particular vessels may be accessible, along with recent inspection results and insights from such inspections. Inspection data may include, for example, client, vessel, winch line/rope, line/rope, anomaly, location, severity, recommendations, and the like.

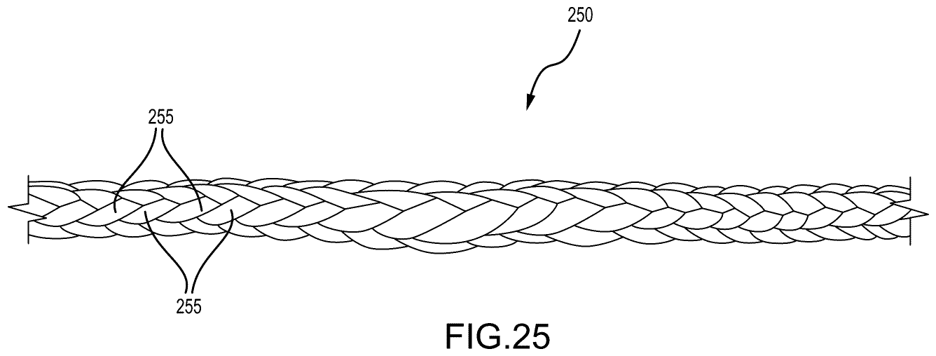

Referring to FIGS. 25, 26, and 27, a rope for evaluation, a rope with identified rope picks, and a rope with pick anomalies identified, according to one or more embodiments of the present disclosure are shown. FIG. 25 illustrates a section of a rope 250 that has been used in maritime operation. Rope 250 includes a number of picks 255, where a pick is the visible section of one strand as it exits and returns into the braid of the rope. A pick distance is the measurement of the length of one pick when the line is under tension.

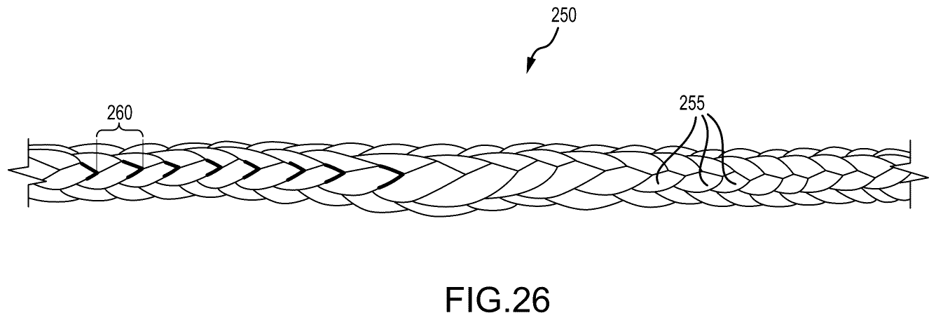

FIG. 26 shows rope 250 with picks 255 identified and also shows a pick distance 260 for a select number of the picks 255. During operation, the sensors, as discussed above, may identify the picks 255 and determine the pick distance 260 for one or more of the picks 255. The number of picks 255 and pick distances 260 for each pick 255 may be provided to an evaluation module, which may then analyze the picks 255 and respective pick distances 260. Analyzation of the picks 255 may include taking images, such as visual, thermal, infrared, x-ray, laser, and the like, which allows anomalies of the rope to be identified. When an anomaly in rope 250 is identified, the location of the anomaly may be known based on the number of picks 255 that are identified and counted. For example, each pick 255 may be assigned a pick number, such that the first pick 255 may be identified as one, the second pick 255 may be identified as two, and so on. Because a pick 255 number is assigned, when an anomaly is identified, an operator may be directed to a specific pick location on rope 250.

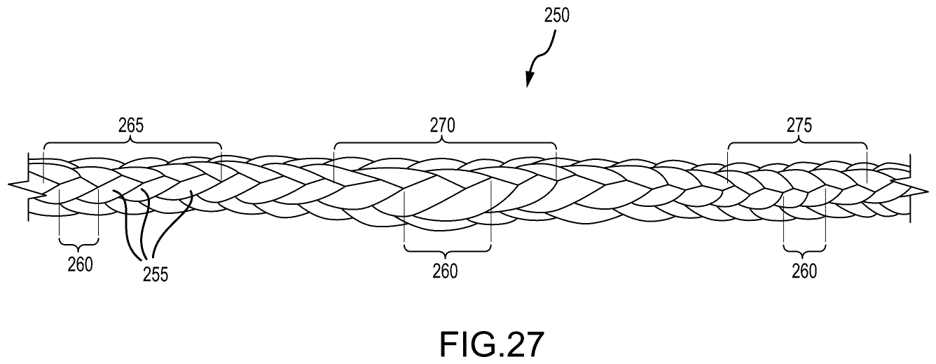

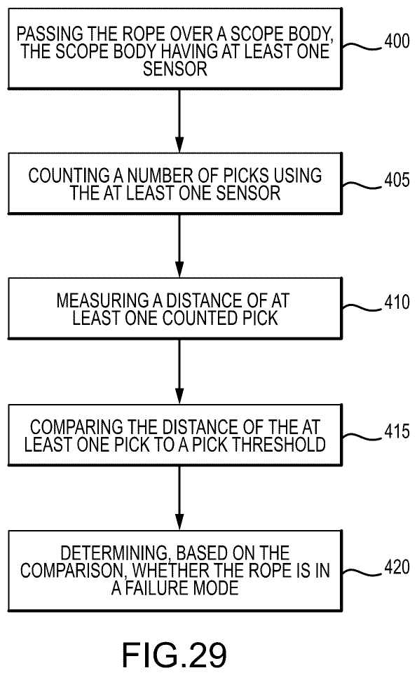

FIG. 27 includes three identified rope sections, first section 265, second section 270, and third section 275. First section 265 shows picks 255 having a specific pick distance 260. Second section 270 shows picks 255 having a pick distance 260 that is greater than the picks 255 in first section 265. Third section 275 shows picks 255 having a pick distance 260 that is less than the picks 255 in the first section 265. The picks 255 in first section 265 illustrate picks 255 that have a starting pick distance 260 or have a pick distance 260 that is under a predefined pick threshold. The starting pick distance may be defined as a pick distance 260 when the rope is new. A pick distance 260 under a predefined pick threshold may be defined as a pick distance 260 that is not outside of a range of change, i.e., a percentage difference, from the pick distance 260 of a starting pick distance. A complete discussion of pick threshold identification is provided below with respect to FIG. 29.

As mentioned above, first section 265 illustrates picks 255 having a pick distance 260 that is within an operational range, i.e., a range that does not indicate a failure mode has been reached. Second section 270, having picks 255 with elongated pick distances 260, indicates that the section of rope has failed, and is thus in a failure mode. Third section 275 illustrates picks 255 having a compressed pick distance 260. The compressed pick distance 260 may indicate that rope 250 has failed. The compressed pick distance 260 further indicate that another section of rope 250 has failed, even if the picks 255 in third section 275 are under a pick threshold. Identification of such a compressed section may thereby indicate that other sections of rope 250 should be evaluated for failure modes.

An evaluation module, such as those discussed herein, may be provided information on picks 255, thereby allowing the evaluation module to identify a rope 250 or sections thereof that are in a failure mode. When a failure mode is identified, the evaluation module may make recommendations for remediating the failure mode. Specific examples of rope 250 remediation are discussed in detail below with respect to FIG. 29.

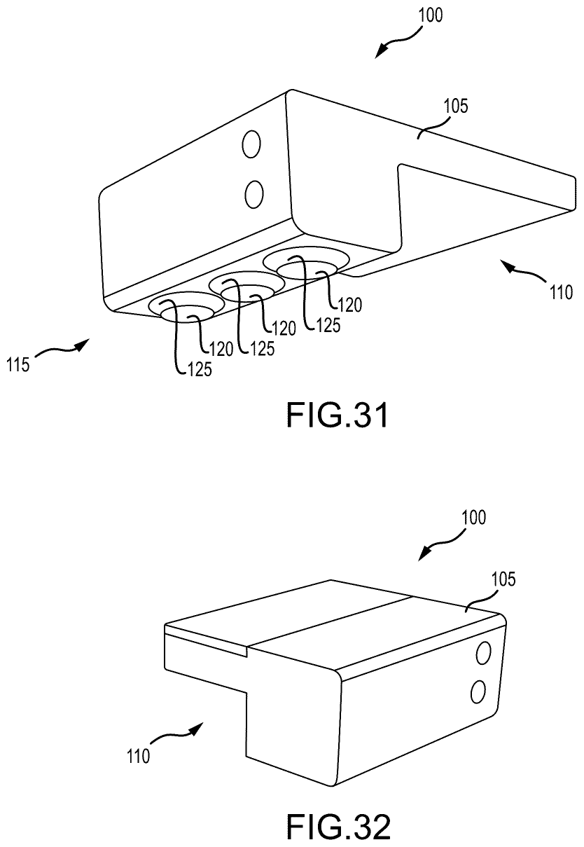

Referring to FIGS. 31 and 32, a front side view and a back side view of a scope, respectively, according to one or more embodiments of the present disclosure are shown. In this embodiment, a scope 100 is shown having a scope body 105. The scope body 105 includes an inlet end 110 and an outlet end 115. Inlet end 110 may be configured to receive a rope as the rope traverses scope body 105. After analysis, the rope may pass out of scope body 105 through outlet end 115. As illustrated, scope body 105 may be generally “L” shaped, have an extension that allows it to be attached to various structures, such as winches that may be present on tug boats, shipping vessels, utility line stringers, and the like.

Scope 100 may further include one or more sensors 120, disposed on scope body 105. In this embodiment, scope 100 includes three sensors 120. Sensors 120 may be used to collect data on the rope as the rope traverses scope 100. Scope 100 may further include one more light sources 125. In this embodiment, scope 100 includes light sources 125 that are integrated within sensors 120.

Referring to FIG. 28, a flowchart for a method for evaluating rope, according to one or more embodiments of the present disclosure is shown. In operation, the method may include passing (block 300) a rope over a scope body. The scope body may have one more sensors and one or more light sources. The geometry of scope body and the configuration of the sensors and/or the light sources may be determined as set forth above with respect to, for example, FIGS. 1-22. As such, the rope may be passed over the scope body, through the scope body, along an external edge of the scope body, or at another location that allows the rope to provide information to the sensors. For the purposes of this disclosure, passing the rope over the scope body includes any of the above types of movement of the rope with respect to the scope body.

In operation, the method may further include detecting (block 305) a rope parameter with the sensor. The detecting may include using the sensors to measure a specific property of the rope. For example, the detecting may include counting a pick number of a rope, determining a pick length, determining a relative pick distance, determining a distance between picks, detecting abrasion, determining the severity of abrasion, detecting localized damage such as cut yarns and cut strands, determining the severity of localized damage, determining the relative distance between failure modes, detecting melting, determining the severity of melting, detecting shock loading, determining the severity of shock loading, detecting UV damage, determining the severity of UV damage, determining an erosion, determining a fray value, determining a thermal property, and/or otherwise measuring aspects of rope.

In operation, the method may further include transferring (block 310) the rope parameter to an evaluation module. The transferring may include sending the rope parameter from the scope to a computing system through, for example, a wired or wireless connection, The computing system may include various computing devices including, but not limited to, desktops, laptops, tablets, phones, proprietary devices, and the like. The transferring may occur on a substantially continuous basis or the rope parameters may be logged and saved by the scope then sent to a separate computing device on a batch basis. In other embodiments, the rope parameters may be sent according to a defined schedule, such as, for example, every 5 seconds, 10 seconds, 30 seconds, every minute, or following a different schedule as defined by an operator. As such, data that is recorded by the sensors may be transferred to the evaluation module for further processing.

In operation, the method may further include detecting (block 320) a rope condition based on the rope parameter. The detecting may be based on a classification of rope parameters that result in specific rope conditions. For example, the rope parameters may indicate that for a particular rope, the rope parameters are within a range that is acceptable, e.g., the make, model, and specification for a rope are known values. Rope conditions may further include an evaluation that determines the relative health of a rope. For example, a rope condition may include a wear value, a wear percentage, a health value, a life expectancy, and the like. The rope condition may further provide an indication as to whether the rope is in a failure mode, which would require a specific action.

In operation, the method may further include evaluating (block 315) the rope parameter. The evaluating may occur by one or more of the scope and/or a separate computing device including an evaluation module. Evaluating may include comparing the rope parameter to a known set of rope parameters that define a condition of a particular rope. The evaluating may use, for example, artificial neural networks and/or other types of machine learning that compare the rope parameter to a known set of parameters. In certain embodiments, more than one rope parameter may be evaluated and compared against a known set of values and/or composite values that define specific rope conditions.

In operation, the method may further include determining (block 325) whether the rope has passed a rope threshold failure based on the rope condition. The rope threshold failure may include a defined value that indicates that the rope is no longer usable for its intended purpose. The rope threshold failure may be based on a rope condition that indicates a certain type or degree of wear has occurred. When such a rope condition is identified, the value of the rope condition may be compared to a predefined threshold failure value, and when the threshold failure value is exceeded, a failure mode may be identified.

When a failure mode is identified, an action may be recommended based on the rope condition. Examples of actions that may be recommended include end-to-end rotation, line-to-line rotation, rope repair, rope replacement, and the like. The method may further include controlling certain variables as the rope passes over a scope body. Such variables may include, for example, perspective, lighting, resolution, throughput, and the like. Those of ordinary skill in the art will appreciate that other types of variables may also be controlled, thereby increasing the effectiveness of the evaluation.

In certain embodiments, the evaluating may further include identifying an anomaly of the rope based on the rope condition. An anomaly may include a specific predefined or otherwise determined condition that identifies how a rope was damaged or otherwise changed. For example, by counting picks and measuring relative pick distances, as will be discussed in greater detail below, a rope anomaly and anomaly location may be identified. In still other embodiments, the rope parameter may be compared to a rope condition library to determine the rope condition. The rope condition library may include a collection of known rope conditions that are associated with specific rope parameters, thereby allowing measured parameters to be compared with known or previously identified values. As previously discussed, the rope condition library may include a collection of data that has been analyzed through the use of, for example, artificial neural networks or other types of machine learning computing devices.

Referring to FIG. 29, a flowchart for a method for evaluating rope, according to one or more embodiments of the present disclosure is shown. In operation, the method may include passing (block 400) the rope over a scope body, where the scope body has at least one sensor. The scope body may also include one or more light sources. The geometry of the scope body and the configuration of the sensors and/or the light sources may be determined as set forth above with respect to, for example, FIGS. 1-22. As such, the rope may be passed over the scope body, through the scope body, along an external edge of the scope body, or at another location that allows the rope to provide information to the sensors. For the purposes of this disclosure, passing the rope over the scope body includes any of the above types of movement of the rope with respect to the scope body.

In operation, the method may further include counting (block 405) a number of picks. The picks may be counted using the sensors and/or light sources and may be counted by, for example, taking images of the rope and determining the number of picks using image detection, as discussed above. In addition to counting the number of picks, a total number of picks may be determined, as well as how many picks are present over a particular distance. As such, a pick count may be determined, where the pick count is the total number of picks in a given horizontal space. The pick count may then be expressed as a number of picks per inch or other unit of distance.

In operation, the method may further include measuring (block 410) a distance of at least one pick. The distance may be measured using the sensors and/or light sources and the distance of each pick may be expressed as a unit of distance, such as inches. A pick distance may include a length of the pick. In certain embodiments, a distance of a plurality of picks may be measured, thereby allowing a comparison between distances of multiple picks.

In operation, the method may further include comparing (block 415) the distance of the at least one pick to a pick threshold. The pick threshold may be determined by defining a pick starting distance, which is the distance of a pick when the rope under tension, e.g., prior to and after use. The pick threshold may thereby represent a percentage change in the pick distance compared to the pick starting distance. For example, a pick threshold may include a change in pick distance that is more or less than two percent from the pick starting distance. In other embodiments, the pick threshold may include a change in pick distance that is more or less than three percent, four percent, five percent, ten percent, or greater than ten percent from the pick starting distance. Thus, the comparison may allow for the identification of a change in a pick distance as a result of use over time.

In operation, the method may further include determining (block 420) whether the rope is in a failure mode based on the pick threshold. When the distance of one or more picks exceeds the pick threshold, the pick may be considered to be in the failure mode. In certain embodiments, a single pick that is over a pick threshold may result in the rope being in a failure mode, while in other embodiments, two or more picks may have to exceed a pick threshold for the rope to be in a failure mode. In still other embodiments, two or more adjacent picks or picks within a predefined distance of each other may have to exceed a pick threshold for the rope to be in a failure mode.

When a rope is in a failure mode, one or more remedial actions may be recommended and subsequently performed. For example, a rope in a failure mode may be taken out of service, may be replaced, a section of the rope may be replaced, the operation may be suspended, and/or a new rope may be used to replace the rope in the failure mode.

Additionally, in certain embodiments, a failure location may be determined based on the counted number of picks. Because each pick of the rope is counted, a location of a potential rope failure may be known, thereby allowing an operator to manually inspect the rope. The operator may then determine whether remedial actions should be taken.

In still other embodiments, one or more pick parameters may be assigned that are specific to the rope. Rope parameters may include, for example, a starting distance for picks for a particular rope, a pick threshold for a particular rope, a rope length, a rope diameter, a rope material, a braid type, and/or other parameters that may be assigned in an evaluation module to allow a failure mode for a particular rope to be determined.

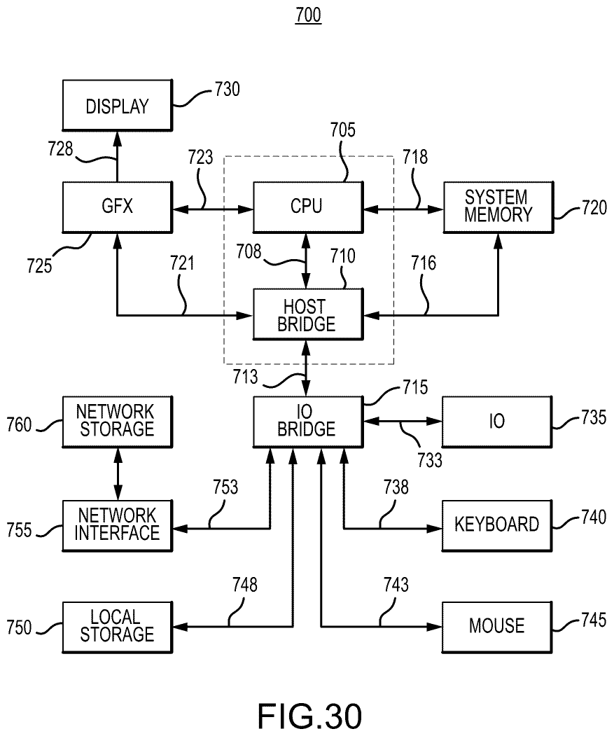

Referring to FIG. 30, a schematic representation of a computer processing device 700 that may be used to implement functions and processes in accordance with one or more examples of the present disclosure is shown. FIG. 30 illustrates a computer processing device 700 that may be used to implement the systems, methods, and processes of this disclosure. For example, computer processing device 700 illustrated in FIG. 12 could represent a client device or a physical server device and include either hardware or virtual processor(s) depending on the level of abstraction of the computing device. In some instances (without abstraction), computer processing device 700 and its elements, as shown in FIG. 12, each relate to physical hardware. Alternatively, in some instances one, more, or all of the elements could be implemented using emulators or virtual machines as levels of abstraction. In any case, no matter how many levels of abstraction away from the physical hardware, computer processing device 700 at its lowest level may be implemented on physical hardware.

FIG. 30 shows a computer processing device 700 in accordance with one or more examples of the present disclosure. Computer processing device 700 may be used to implement aspects of the present disclosure, such as an orchestrator, a gateway manager, a cloud monitor, a local storage, a cloud-based storage, or any other device that may be used implementing the systems and methods for managing data discussed herein. Computer processing device 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computer processing device 700 may include one or more core logic devices such as, for example, host bridge 710 and input/output (“IO”) bridge 715.

CPU 705 may include an interface 708 to host bridge 710, an interface 718 to system memory 720, and an interface 723 to one or more IO devices, such as, for example, graphics processing unit (“GFX”) 725. GFX 725 may include one or more graphics processor cores (not independently shown) and an interface 728 to display 730. In certain examples, CPU 705 may integrate the functionality of GFX 725 and interface directly (not shown) with display 730. Host bridge 710 may include an interface 708 to CPU 705, an interface 713 to IO bridge 715, for examples where CPU 705 does not include interface 718 to system memory 720, an interface 716 to system memory 720, and for examples where CPU 705 does not include integrated GFX 725 or interface 723 to GFX 725, an interface 721 to GFX 725. One of ordinary skill in the art will recognize that CPU 705 and host bridge 710 may be integrated, in whole or in part, to reduce chip count, motherboard footprint, thermal design power, and power consumption. IO bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi®, Bluetooth®, or any other network protocol suitable to facilitate networked communications. Computer processing device 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computer processing device 700 and may be accessible to computer processing device 700 via one or more network interfaces provided by one or more network interface devices 755.

One of ordinary skill in the art will recognize that computer processing device 700 may include one or more application-specific integrated circuits (“ASICs”) that are configured to perform a certain function, such as, for example, hashing (not shown), in a more efficient manner. The one or more ASICs may interface directly with an interface of CPU 705, host bridge 710, or IO bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, IO bridge 715, or ASICs or various sub-sets, super-sets, or combinations of functions or features thereof, may be integrated, in whole or in part, or distributed among various devices in a way that may vary based on an application, design, or form factor in accordance with one or more example examples. As such, the description of computer processing device 700 is merely exemplary and not intended to limit the type, kind, or configuration of components that constitute a computing system suitable for performing computing operations, including, but not limited to, hashing functions. Additionally, one of ordinary skill in the art will recognize that computer processing device 700, an application-specific computing system (not shown), or combination thereof, may be disposed in a stand-alone, desktop, server, or rack mountable form factor.

One of ordinary skill in the art will recognize that computer processing device 700 may be a cloud-based server, a server, a workstation, a desktop, a laptop, a netbook, a tablet, a smartphone, a mobile device, and/or any other type of computing system in accordance with one or more example examples.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and Blu-ray disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A system for evaluating rope, the system comprising:
a scope body having an inlet end defining an inlet and an outlet end defining an outlet, the scope body defining a geometry to receive a rope;
at least one light disposed in the scope body to illuminate the rope as it traverses the scope body;
at least one sensor disposed in the scope body, the at least one sensor to sense at least one rope parameter from the rope as the rope traverses through the scope body; and
an evaluation module electrically connected to the at least one sensor to receive the at least one rope parameter and determine a rope condition based on the at least one rope parameter.

2. The system of claim 1, further comprising an attachment mechanism connected to the scope body to attach the system to a structure.

3. The system of claim 1, wherein the scope body comprises an accurate geometry.

4. The system of claim 1, wherein the scope body comprises a substantially curvilinear geometry that encircles the rope.

5. The system of claim 1, wherein the scope body comprises a retractable portion.

6. The system of claim 1, wherein the scope body comprises a substantially circular geometry.

7. The system of claim 1, wherein the inlet end comprises a greater volume than the outlet end.

8. The system of claim 1, wherein the scope body further comprises a support structure to hold the rope as the rope traverses the scope body.

9. The system of claim 1, wherein the rope traverses the scope body along an external portion of the scope body.

10. A method of evaluating a rope, the method comprising:
passing the rope over a scope body, the scope body having at least one sensor;
detecting a rope parameter with the sensor;
transferring the rope parameter to an evaluation module;
evaluating the rope parameter;
detecting a rope condition based on the evaluation of the rope parameter; and
determining whether the rope has passed a rope threshold failure based on the detected rope condition.

11. The method of claim 10, wherein the evaluating, detecting, and determining occurs in substantially real time.

12. The method of claim 10, further comprising controlling at least one of a perspective, a lighting, a resolution, and a throughput.

13. The method of claim 10, further comprising identifying an anomaly of the rope based on the detected rope condition.

14. The method of claim 10, further comprising comparing the detected rope parameter to a plurality of entries in a rope condition library to determine the rope condition.

15. The method of claim 10, further comprising automatically recommending an action based on the rope condition.

16. The method of claim 15, wherein the recommended action comprises at least one of end-to-end rotation, line-to-line rotation, repair, and replacement.

17. A method of evaluating a rope, the method comprising:
passing the rope over a scope body, the scope body having at least one sensor;
counting a number of picks using the at least one sensor;
measuring a distance of at least one counted pick;
comparing the distance of the at least one pick to a pick threshold; and
determining, based on the comparison, whether the rope is in a failure mode.

18. The method of claim 17, further comprising determining a failure location based on the counting of the number of picks.

19. The method of claim 17, wherein the failure mode occurs when the distance of the pick is at least greater than 2 percent from a starting distance of the picks.

20. The method of claim 17, further comprising assigning at least one pick parameter specific to the rope.

21. A method of evaluating a rope, the method comprising:
sensing a rope parameter as the rope traverses a scope body;
evaluating the rope parameter;
detecting a rope condition based on the evaluation of the rope parameter; and
determining whether the rope has passed a rope threshold failure based on the detecting.

22. A system for evaluating rope, the system comprising:
a scope body having a notch disposed longitudinally along the scope body;
at least one sensor disposed in the scope body in the notch, the at least one sensor to sense at least one rope parameter from the rope as the rope passes by the scope body;
an evaluation module electrically connected to the at least one sensor to receive the at least one rope parameter and determine a rope condition based on the at least one rope parameter.
